(19) United States
(12) Patent Application Publication
(10) Pub. No.: US 2003/0094724 A1
(43) Pub. Date: May 22, 2003

(54) Continuous vacuum injection press

(76) Inventor: Thaddeus Soberay, Brecksville, OH (US)

Correspondence Address: WATTS, HOFFMANN, FISHER & HEINKE CO., L.P.A., P.O. Box 99839, Cleveland, OH, 44199-0830, US

(21) Appl. No.: 09/992,679

(22) Filed: Nov. 19, 2001

(51) Int. Cl. B29C 45/00; B29C 45/17

(52) U.S. Cl. 264/101; 425/130; 425/192 R; 425/556; 264/328.1

(57) ABSTRACT

A vacuum injection press for producing molded parts offering near continuous operation, improved part handling capabilities and increased processing speed. The press includes a molding chamber, a door, a parts receiving receptacle and a source of vacuum. A structure defines a sealable molding chamber having an interior region and a passage configured to permit parts molded in the molding chamber to pass into a discharge region. A door is moveable for controlling communication between the interior region and the discharge region. A parts receiving receptacle is moveable into and out of the discharge region. The receptacle defines a parts receiving zone that is isolated from a remainder of the discharge region. A source of vacuum includes a controls for communicating the vacuum source with the molding chamber and for controlling the communication of the vacuum source with the parts receiving zone. A method of producing molded parts is provided.

### TECHNICAL FIELD

The present invention relates generally to molding and, in particular, to a vacuum injection press offering near continuous operation, improved part handling capabilities and increased processing speed.

### BACKGROUND ART

Conventional molding machines currently exist which utilize a vacuum chamber to aid in the molding process. An example of such a press is disclosed in U.S. Pat. No. 4,666,551 to Soberay, which is incorporated herein by reference in its entirety. These types of machines have been used typically to produce low volumes of molded products and/or multi-layer circuit boards. When used to produce molded products, mold cavities are filled with “preforms” by the operator. The press closes and the molding chamber is evacuated. The products are then molded while being subjected to vacuum, heat and mechanical clamping forces exerted by the mold halves.

Vacuum techniques have also been tried in an effort to improve injection molding. In the past, specialty vacuum molds having discharge ports have been created to remove air from the cavity. These specialty vacuum molds can be very expensive to manufacture and the ports are subject to plugging which over time ultimately causes degradation of the molded product.

Improved molding machines have been developed which utilize injection molding in combination with an evacuated atmosphere to provide a cost effective and efficient molding system. An example of such a vacuum press is disclosed in U.S. Pat. No. 6,106,269 to Soberay, which is incorporated herein by reference in its entirety.

In practicing the invention as disclosed in '269 to Soberay, a need for more continuous operation, improved part handling capabilities and increased processing speed was discovered. Conventional techniques tend to limit the cycle speed of the press, and thus, limit production output. After each molding cycle, the vacuum is released from the molding chamber as the part is allowed to exit the chamber. Another vacuum must be drawn prior to beginning the next molding cycle. Therefor, the output of the molding machine may be dependent upon the capabilities of the vacuum pump. In other words, the cycle time of the mold process is directly limited by the time the pump requires to evacuate the molding chamber. Potential production time is lost waiting for a vacuum to be drawn for each molding cycle.

Several solutions have been suggested to capture the processing time lost waiting for a new vacuum to be drawn. One solution suggested in the prior art to reduce cycle time is the use of an accumulator tank. The tank is used to reduce the time required to draw a vacuum. However, this solution increases equipment cost, complexity of the system and only somewhat increases processing speed.

Drawing a new vacuum between each molding cycle has other inherent disadvantages. In prior art atmospheric injection molding, the molding compound entering the mold is subject to air, moisture and other foreign volatiles. Vacuum molding portions are typically designed with passages to allow the air, moisture and other volatiles to bleed out of the cavity as the molding compound is injected. Although in theory molding compound forces outs these substances, between each cycle they are reintroduced to the molding chamber when the vacuum is released.

Furthermore, energy costs are increased as the vacuum pump operates more frequently and at an increased variant pace. Operating the vacuum pump in this manner also decreasing pump life while increasing maintenance costs and operational down time.

Thus, a need exists for a vacuum injection press offering near continuous operation, improved part handling capabilities and increased processing speed which advantageously allows greater part output and reduced operational costs.

### DISCLOSURE OF INVENTION

The present invention provides a new and improved part handling apparatus and method of use which utilizes injection molding in combination with vacuum to provide a cost effective and efficient molding system.

A vacuum injection press includes a sealable molding chamber, a door, a parts receiving receptacle and a source of vacuum.

A frame structure defines a sealable molding chamber having a passage communicating an interior region of the chamber with a parts discharge region spaced from the interior region. The passage is configured to permit parts molded in the molding chamber to pass through the passage and into the parts discharge region.

A door is moveable between open and closed positions for controlling communication between the interior chamber region and the parts discharge region. The door is arranged such that when in its opened position the interior region of the molding chamber communicates with the parts discharge region through the passage. When in its closed position, the door substantially inhibits fluid communication between the molding chamber and the parts discharge region.

A parts receiving receptacle is moveable into and out of the parts discharge region. The receptacle is sealingly engageable with the structure such that when the structure is engaged by the receptacle, the receptacle defines a parts receiving zone. The zone is isolated from a remainder of the parts discharge region. The passage communicates the molding chamber with the zone when the door moves to an opened position so that parts discharged from the molding chamber enter the zone.

A source of vacuum includes a first control for communicating the vacuum source with the molding chamber and a second control for controlling the communicating the vacuum source with the parts receiving zone defined by the parts receiving receptacle under predetermined operating conditions.

The vacuum injection press may comprise at least one receptacle engagement surface adjacent the parts discharge region comprising a sealing element. The sealing element is adapted to sealingly engage a parts receptacle such that the parts discharge region and the parts receiving zone may be subject to a common vacuum.

The vacuum injection press may comprise a fluid pressure actuator used to raise a parts receptacle from a detached position to a sealably engaged position adjacent the parts discharge region, such that the parts discharge region and the parts receiving zone may be subject to a common vacuum.

The vacuum injection press may comprise a parts receptacle transport system used to move an empty parts receptacle in a direction toward the parts discharge region, and to move a parts receptacle containing a predetermined capacity of molding parts in a direction away from the parts discharge region.

In an alternative embodiment of the present invention, the vacuum injection press comprises a frame structure defining a sealable molding chamber, a sealable lower chamber, a parts receptacle, a door assembly and a source of vacuum.

A frame structure defines a sealable molding chamber having at least one access opening by which molded products exit the molding chamber.

A sealable lower chamber has at least two access openings. At least one access opening is configured to permit parts molded in the molding chamber to enter the lower chamber. At least one opening is configured to permit parts molded in the lower chamber to exit the lower chamber.

A parts receptacle is adapted to sealably engage the at least one opening by which molded parts exit the lower chamber. The parts receptacle is adapted to contain a plurality of molded parts, such that the molding chamber, the lower chamber and an interior of a parts receptacle may be in fluid communication and subject to a common vacuum.

A door assembly is movable between open and closed positions and operative to inhibit access to the lower chamber from the molding chamber when in a closed position. The door assembly allows access to the lower chamber from the molding chamber when in an open position.

A source of vacuum includes control means for subjecting the molding chamber and the lower chamber to a vacuum. The molding chamber and the lower chamber may be independently subject to either substantially equal or unequal vacuum pressure.

A method, practiced in accordance with an exemplary embodiment of the invention, includes the first steps of subjecting a sealable molding chamber and a parts discharge region to a common vacuum, performing at least one molding cycle, and filling a parts receptacle with molded parts to a predetermined capacity.

The method includes the next steps of closing a door, wherein the door is arranged such that when in its closed position, the door substantially inhibits fluid communication between the molding chamber and a parts discharge zone, releasing vacuum from a parts receiving zone, and allowing the parts receiving zone to return to about atmospheric pressure.

The method includes the next steps of moving a parts receptacle filled with molded parts to a predetermined capacity in a direction away from the parts discharge region, and moving an empty parts receptacle to a position adjacent to the parts discharge region.

The method includes the final steps of subjecting the sealably molding chamber and the parts discharge region to a common vacuum, and opening the door, wherein the door is arranged such that when in its opened position the interior region of the molding chamber communicates with the parts discharge region through the passage.

Additional features will become apparent and a fuller understanding obtained by reading the following detailed description made in connection with the accompanying drawings.

### BRIEF DESCRIPTION OF DRAWINGS

FIG. 1 is a side elevational view of a vacuum injection press constructed in accordance with one embodiment of the present invention;

FIG. 2 is another side elevational view of the vacuum injection press, rotated 90° from the position shown in FIG. 1 and with portions broken away to show interior details; and

FIG. 3 is a sectional view as seen from the plane indicated by the line 3-3 in FIG. 1 showing a molded part within a parts receptacle.

### BEST MODE FOR CARRYING OUT THE INVENTION

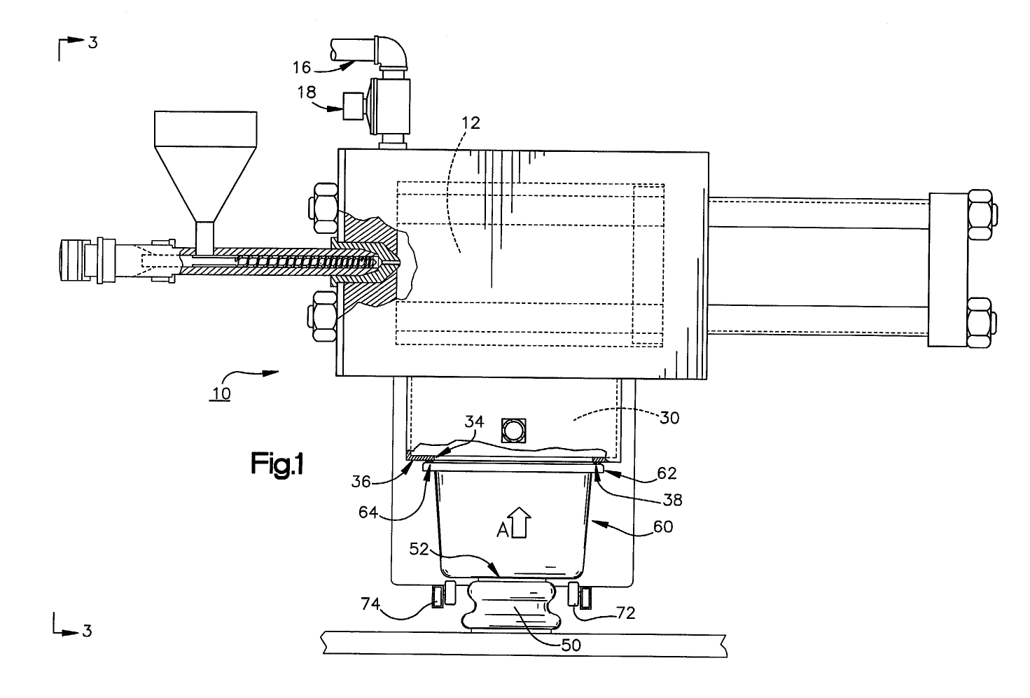

FIG. 1 illustrates the overall construction of a vacuum injection press 10 constructed in accordance with one embodiment of the present invention. Generally, the press produces molded parts by combining a conventional mechanical press and injection molding techniques. The parts may be plastic, rubber or any other suitable composition apparent to others with ordinary skill in the art. During a molding cycle, mold portions are brought together to define an enclosed cavity that is filled with molding compound. The enclosed cavity is subject to vacuum and mechanical forces during a molding cycle. At the conclusion of the molding cycle, the mold halves are separated and the molded part falls into a parts receptacle. Further details concerning the specific apparatus directed toward the molding processes of the vacuum press are disclosed in U.S. Pat. No. 6,106,269 to Soberay, which is incorporated herein by reference in its entirety. The present invention is directed to more continuous operation, improved part handling capabilities and increased processing speed for the vacuum injection press 10.

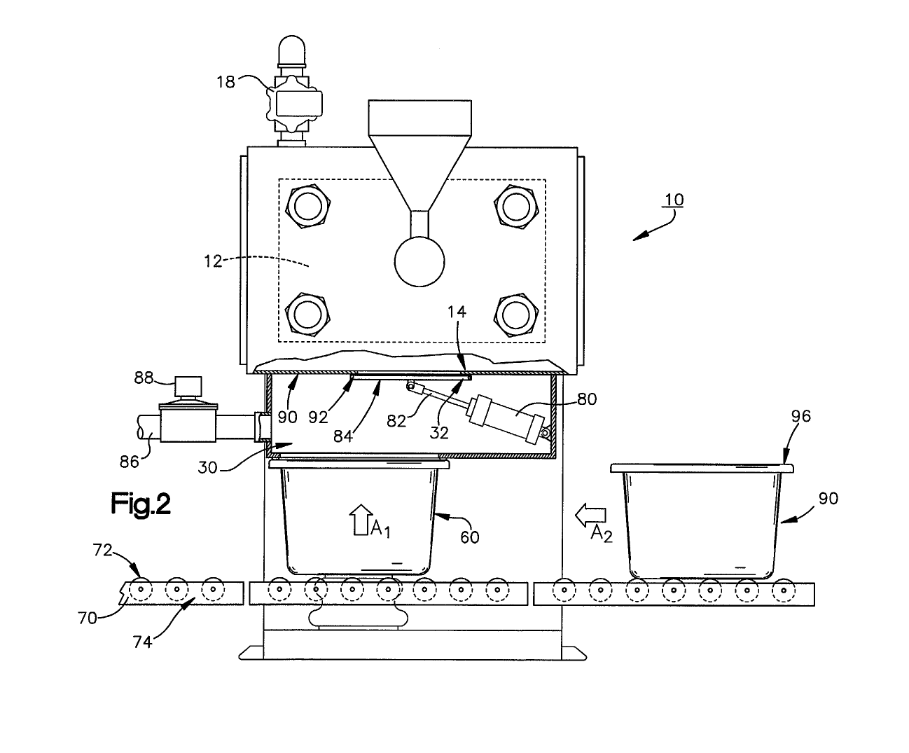

Again referring to FIG. 1, a side elevational view of a vacuum injection press 10 constructed in accordance with one embodiment of the invention is illustrated. The press has a frame structure defining an injection molding chamber 12. The chamber 12 is generally six sided and has at least one access opening 14, as shown in FIG. 2, by which molded parts exit the chamber 12. The access opening is of sufficient area to allow molded parts to pass through without clogging or damage to the parts. In one embodiment, the access opening 14 is formed in a lower structural surface. The access opening 14 is positioned to permit gravity to advantageously impact upon molded parts, causing the parts to fall out of the chamber 12.

As disclosed in U.S. Pat. No. 6,106,269 to Soberay, the press assembly 10 also includes first and second mold portions, fluid pressure operated means for maintaining clamping contact between the first and second mold portions, an injection molding unit (not shown) located outside of the chamber 12 for providing molding compound to a cavity defined by the mold portions, and means for delivering molding compound from the injection unit to the cavity.

The molding chamber 12 may be evacuated by an upper vacuum line 16 leading to a system vacuum pump (not shown). The upper vacuum line 16 communicates with the molding chamber 12 via an upper control valve 18. During production operation of the press, the system vacuum pump evacuates the molding chamber 12.

In an alternative embodiment, the system vacuum pump may be replaced with two vacuum pumps. The upper vacuum pump may be used to evacuate the upper chamber 12. The alternative embodiment also includes a lower vacuum pump.

The molding chamber 12 is generally in fluid communication with a lower chamber 30. The lower chamber 30 has at least one upper opening 32 by which molded products enter the lower chamber 30. As illustrated in FIG. 1, in one embodiment, the access opening 32 is formed in an upper structural surface of the lower chamber 30. As illustrated in FIG. 1, the upper opening 32 of the lower chamber 30 may be structurally common to the access opening 14 of the molding chamber 12.

In an alternative embodiment, a passage may be included from the molding chamber directly to a parts discharge region without the use of a lower chamber.

As illustrated, the lower chamber 30 has at least one lower opening 34 in a lower structural surface. Preferably, the lower opening 34 has a cross-sectional area equal to or greater than a cross-sectional area of the upper access opening 32. Both the lower opening 34 and the upper opening 32 are sufficiently sized to allow molded parts to pass through without clogging or damage to the parts.

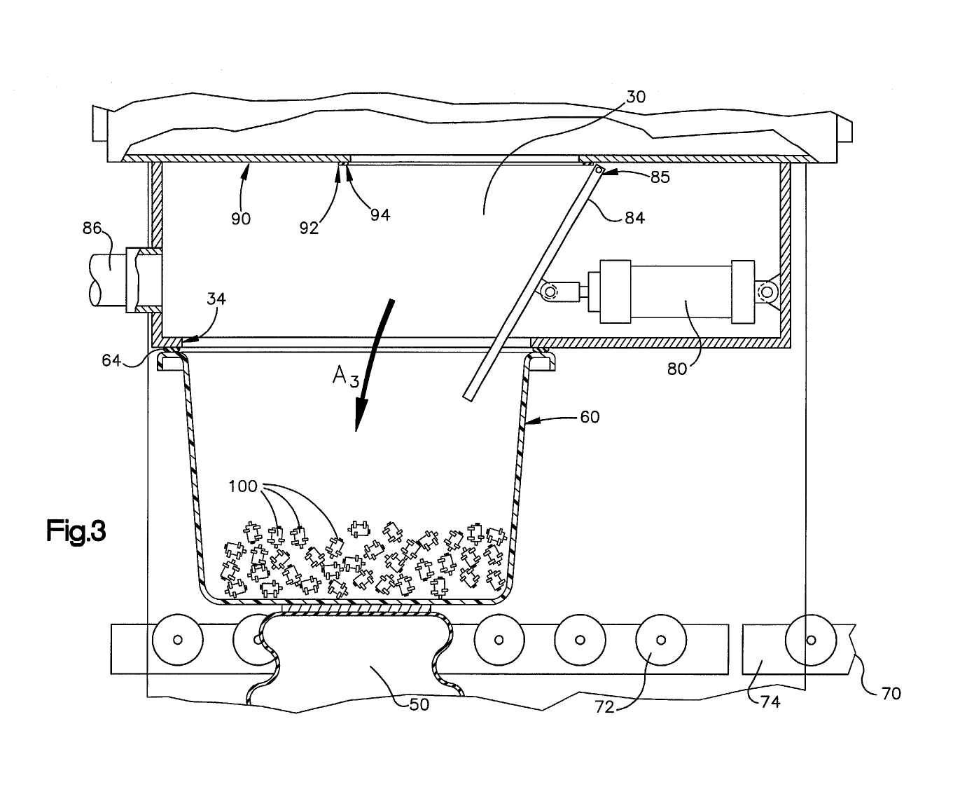

As illustrated in FIG. 3, a lower exterior surface 36 of the lower chamber 30 is generally planar. The lower exterior surface 36 includes a receptacle engagement surface 38 circumferentially positioned adjacent to the lower opening 34. The receptacle engagement surface 38 is generally planer and suitable for hermetically adhering with a sealing element 64, as shown in FIG. 3. The sealing element 64 may be a conventional O-ring and is affixed to the mounting surface 38 of the lower exterior surface 36 by permanent adhesive or other suitable means.

Also illustrated in FIG. 1, an air stroke actuator 50 is vertically positioned below the lower opening 34. The top support surface 52 of the actuator 50 is generally planar. In one embodiment, the support surface 52 is shaped to support a parts receptacle 60. In one embodiment, the parts receptacle 60 rests and is generally centered upon the support surface 52. The actuator 50 contains means to raise and lower the parts receptacle 60 in the direction of arrow A₁ as illustrated in FIG. 1. It view of this disclosure, it should be understood by those skilled in the art other suitable means to raise and lower a parts receptacle 60 may be used.

The parts receptacle 60 may be a commercially available container, or the like, and is sized to contain a plurality of molded parts 100. The parts receptacle 60 includes a lip 62 positioned circumferentially around a top portion of the receptacle. The lip 62 may function as a sealing surface for the lower O-ring 64 adhered to the receptacle engagement surface 38 of the lower exterior surface 36. In one embodiment, the lip 62 of the receptacle may include a sealing element adapted to seal with the receptacle engagement surface 38.

A supply of parts receptacles 60 are transported, either individually or as a series, to a location vertically above the actuator 50 by a conveyor system 70. The system 70 may include a series of conventional wheels 72 mounted on support rails 74. The rails 74 are spaced apart a distance less than the width of a parts receptacle 60.

Referring now to FIG. 2, a side elevational view of the vacuum injection press 10 is illustrated, rotated 90° from the position shown in FIG. 1 and with portions broken away to show interior details, including a door assembly. The door assembly includes a door closing cylinder 80, a connecting rod 82 and sealing flipper door 84.

The door closing cylinder 80 is mounted within the lower chamber 30. In one embodiment, the cylinder 80 is attached to an inner wall of the chamber 30 by clevis-style mounting hardware. It should be understood by those skilled in the art that other mounting means may be used. The cylinder is adapted to axially displace a connecting rod 84 rotationally attached to the sealing flipper door 84. The cylinder 80 may be powered by air, hydraulics or any other suitable method. As best shown in FIG. 2, in an extended position, the cylinder 80 acts to position the door 84 such that the lower chamber 30 is hermetically sealed from the molding chamber 12. The door 84 is generally planar and, as best shown in FIG. 3, one edge 85 of the door may be mounted to a surface 90.

A lower exterior surface 90 of the molding chamber 12 is generally planar. The lower exterior surface 90 includes a surface 92 circumferentially positioned adjacent to the access opening 14. As discussed, the upper opening 32 of the lower chamber 30 may be structurally common to the access opening 14 of the molding chamber 12. The surface 92 is generally planer and suitable for adhering with a sealing element 94, best shown in FIG. 3. The sealing element 94 may be a conventional O-ring.

The lower chamber 30 may be evacuated by a lower vacuum line 86 leading to the system vacuum pump (not shown). The lower vacuum line 86 communicates with the lower chamber 30 via a lower control valve 88. It will be apparent to others skilled in the art that conventional piping designs and techniques may be used to sufficiently connect the system vacuum pump to the upper chamber 12 and the lower chamber 30.

In an alternative embodiment previously discussed, separate vacuum sources evacuate the lower chamber 30 and the molding chamber 12. In this embodiment, an upper vacuum pump (not shown) communicates with the molding chamber 12 via an upper control valve 18. Independently, a lower vacuum pump (not shown) communicates with the lower chamber 30 via a lower control valve 88.

The molding chamber 12 is generally in fluid communication with the lower chamber 30. When the flipper door 84 is in the open position, the upper vacuum pump works in concert with the lower vacuum pump evacuate the molding chamber 12 and the lower chamber 30. At essentially all times during molding production, the molding chamber 12 is evacuated.

When the flipper door 84 is in the closed position, the common vacuum pump works to evacuate the molding chamber 12 only. During this part of the production cycle, to be discussed later in more detail, a parts receptacle 60 may be removed and replaced with a replacement parts receptacle 90.

Referring now to FIG. 3, a sectional view as seen from the plane indicated by the line 3-3 in FIG. 1 showing a molded part 100 within a parts receptacle 60 is illustrated. The flipper door 84 is illustrated in the open position.

Details concerning the actual molding processes of the vacuum press are disclosed in U.S. Pat. No. 6,106,269 to Soberay, which is incorporated herein by reference in its entirety. The method of operation of the vacuum injection press as it relates to improved part handling capabilities will now be discussed.

A control panel (not shown) generally regulates the operation of the vacuum press 10. At the initiation of a molding cycle, the part handling apparatus of the press 10 are configured as shown in FIG. 3. The flipper door 84 is in the open position. The air stoke actuator 50 has been activated by the control panel to raise a parts receptacle 60. The receptacle 60 is in a raised position such that the top surface of the lip 62 abuts the lower O-ring 64 adhered to the receptacle engagement surface 38. In the configuration shown in FIG. 3, the molding chamber 12 and the lower chamber 30 form a common hermetically sealed region.

In this configuration, the molding process transpires within the molding chamber 12. As each molded part is formed, the mold halves separate and a molded part falls vertically under the force of gravity. As the part falls, the part travels through the access opening 14 of the molding chamber 12 and into the lower chamber 30.

Within the lower chamber 30, the part continues to fall. The part may contact a top surface of the flipper door 84. As best illustrated in FIG. 3, the door 84 is angled with respect to a horizontal floor surface when in the open position. Parts that contact the door 84 are advantageously directed toward the lower opening 34, generally in the direction of arrow A₃ as illustrated in FIG. 3.

A parts receptacle 60 is positioned to circumferentially encompass the lower opening 34. In this configuration, a molded part 100 traveling through the lower opening 34 must come to rest in the parts receptacle 60. As illustrated in FIG. 3, a relatively large number of molded parts 100 may be contained in a parts receptacle 60.

After a predetermined number of molding cycles are complete, the parts receptacle 60 is substantially full of parts and reaches a predetermined capacity. It should be apparent to those skilled in the art in view of this disclosure, that other ways of determining this capacity are possible, such as weighing the parts receptacle as it fills. At this point in production, the molding processes may be temporarily suspended. The cylinder 80 acts to extend the connecting rod 82, thereby translated the flipper door 84 to the closed position. In this configuration, the molding chamber 12 and the lower chamber 30 are isolated.

During this period of atmospheric isolation, the upper vacuum pump continues to evacuate the molding chamber 12 as required to maintain a vacuum.

After the flipper door 84 seals the lower chamber 30, the process of changing the parts receptacle is initiated. First, the chamber 30 is returned to ambient conditions using control valve 86. The lower vacuum pump discontinues pumping and the lower vacuum line valve 88 is closed. The air stroke actuator 50 is slowly contracted to lower the parts receptacle 60. The combined weight of the parts receptacle 60 and the parts 100 within the receptacle acts to break the seal.

In one embodiment, the vacuum may be compromised by pumping air into the lower chamber 30 to effectively break the seal between the parts receptacle 60 and the lower O-ring 64 A solenoid valve (not shown) piped in communication with a common vacuum source may be used to regulate air flow into the lower chamber 30.

After the seal is broken, the parts receptacle 60 is lowered to the elevation of the conveyer system 70. In the lowered position, the parts receptacle 60 again rests upon the wheels 72 of the conveyer 70. The full parts receptacle 60 is now removed. As best seen in FIG. 2, a replacement parts receptacle 90 is transported along the conveyer 70 in the direction of the arrow A₂.

Once the replacement parts receptacle 90 is centered over the air stroke actuator 50, the replacement parts receptacle 90 is elevated into a raised position. The lip 96 of the replacement receptacle hermetically seals with the lower O-ring 64. The lower chamber 30 is again isolated from ambient conditions. The lower vacuum line valve 88 is opened and the system vacuum pump evacuates the lower chamber 30.

Once the lower chamber 30 reaches the same atmospheric conditions as the molding chamber 12, the cylinder 80 is slowly retracted. At this point, essentially no force is required to break the seal between the door 84 and the upper O-ring 94.

The rod 82 fully retracts, effectively returning the flipper door 84 to the open position. The molding process continues within the molding chamber 12.

The disclosed invention provides a new and improved part handling apparatus and method for a molding machine which utilizes injection molding in combination with vacuum to provide a cost effective and efficient molding system. The molding chamber is under vacuum at all times during operation. The maintained evacuated molding atmosphere eliminates air in the mold chamber, permitting a shorter mold cycle and increasing production output. Further, the maintained vacuumed atmosphere permits a mold cycle time independent of any vacuum pump limitations.

Although the invention has been described with a certain degree of particularity, it should be understood that those skilled in the art can make various changes to it without departing from the spirit or scope as hereinafter claimed.

What is claimed is:

1. A vacuum injection press, comprising:
a) a structure defining a sealable molding chamber and a passage communicating an interior region of said chamber with a parts discharge region spaced from said interior region, said passage being configured to permit parts molded in said molding chamber to pass through said passage and into said parts discharge region;
b) a door moveable between open and closed positions for controlling communication between said interior chamber region and said parts discharge region, through said passage;
c) said door arranged such that when in its opened position said interior region of said molding chamber communicates with said parts discharge region through said passage and when in its closed position, said door substantially inhibits fluid communication between said molding chamber and said parts discharge region;
d) a parts receiving receptacle moveable into and out of said parts discharge region and sealingly engageable with said structure such that when said structure is engaged by said receptacle, said receptacle defines a parts receiving zone that is isolated from a remainder of the parts discharge region and said passage communicating said molding chamber with said zone when said door moves to said opened position so that parts discharged from said molding chamber enter said zone; and
e) a source of vacuum including a first control for communicating said vacuum source with said molding chamber and a second control for controlling the communication of said vacuum source with said parts receiving zone defined by said parts receiving receptacle under predetermined operating conditions.

2. A vacuum injection press as claimed in claim 1 comprising:
a) an injection molding unit located outside of said molding chamber for providing molding compound to a cavity defined by mold portions disposed within said molding chamber; and
b) means for delivering said molding compound from said injection unit to said cavity defined by said mold portions.

3. A vacuum injection press as claimed in claim 1 comprising at least one receptacle engagement surface adjacent said parts discharge region comprising a sealing element, wherein said sealing element is adapted to sealingly engage a parts receptacle such that said parts discharge region and said parts receiving zone may be subject to a common vacuum.

4. A vacuum injection press as claimed in claim 1 wherein a fluid pressure actuator is used to raise a said parts receptacle from a detached position to a sealably engaged position adjacent said parts discharge region, such that said parts discharge region and said parts receiving zone may be subject to a common vacuum.

5. A vacuum injection press as claimed in claim 1 wherein a parts receptacle transport system is used to move a said parts receptacle containing no molding parts in a direction toward said parts discharge region, and to move a said parts receptacle containing a predetermined capacity of molding parts in a direction away from said parts discharge region.

6. A vacuum injection press, with improved part handling capabilities for molded parts, comprising:
a) a frame structure defining a sealable molding chamber, said molding chamber having at least one access opening by which molded products exit said molding chamber;
b) a sealable lower chamber, said lower chamber having at least two access openings, at least one opening configured to permit parts molded in said molding chamber to enter said lower chamber and at least one opening configured to permit parts molded in said lower chamber to exit said lower chamber,
c) a parts receptacle, said parts receptacle adapted to sealably engage said at least one opening by which molded parts exit said lower chamber, wherein said parts receptacle is adapted to contain a plurality of molded parts, such that said molding chamber, said lower chamber and an interior of a said parts receptacle may be in fluid communication and subject to a common vacuum;
d) a door assembly movable between open and closed positions and operative to inhibit access to said lower chamber from said molding chamber when in a closed position and to allow access to said lower chamber from said molding chamber when in an open position; and
e) a source of vacuum including control means for subjecting said molding chamber and said lower chamber to a vacuum, such that said molding chamber and said lower chamber may be independently subject to either substantially equal or unequal vacuum pressure.

7. A vacuum injection press as claimed in claim 6 comprising:
a) an injection molding unit located outside of said molding chamber for providing molding compound to a cavity defined by mold portions disposed within said molding chamber; and
b) means for delivering said molding compound from said injection unit to said cavity defined by said mold portions.

8. A vacuum injection press as claimed in claim 6 comprising at least one receptacle engagement surface adjacent said lower chamber comprising a sealing element, wherein said sealing element is adapted to sealingly engage a parts receptacle such that said lower chamber and an interior of a said parts receptacle may be subject to a common vacuum.

9. A vacuum injection press as claimed in claim 6 wherein a fluid pressure actuator is used to raise a said parts receptacle from a detached position to a sealably engaged position adjacent said lower chamber, such that said lower chamber and an interior of a said parts receptacle may be subject to a common vacuum.

10. A vacuum injection press as claimed in claim 6 wherein a parts receptacle transport system is used to move a said parts receptacle containing no molding parts in a direction toward said lower chamber, and to move a said parts receptacle containing a predetermined capacity of molding parts in a direction away from said lower chamber.

11. A method of molding a part using a vacuum injection press comprising the steps of:
a) subjecting a sealable molding chamber and a parts discharge region to a common vacuum, wherein said molding chamber is defined by a frame structure and includes a passage communicating an interior region of said chamber with said parts discharge region spaced from said interior region, said passage being configured to permit parts molded in said molding chamber to pass through said passage and into said parts discharge region;
b) performing said at least one molding cycle, said cycle defined by the process of injecting molding compound into a cavity defined by mold portions disposed within said molding chamber to produce at least one molded part;
c) filling a parts receptacle with molded parts to a predetermined capacity, wherein said parts receiving receptacle is moveable into and out of said parts discharge region and sealingly engageable with said structure such that when said structure is engaged by said receptacle, said receptacle defines a parts receiving zone that is isolated from a remainder of the parts discharge region and said passage communicating said molding chamber with said zone;
d) closing a door, wherein said door is arranged such that when said door is in its closed position, said door substantially inhibits fluid communication between said molding chamber and said parts discharge zone;
e) releasing vacuum from said parts receiving zone, allowing said parts receiving zone to return to about atmospheric pressure;
f) moving a said parts receptacle filled with molded parts to a predetermined capacity in a direction away from said parts discharge region;
g) moving an empty parts receptacle to a position adjacent to said parts discharge region;
h) subjecting said sealably molding chamber and said parts discharge region to a common vacuum; and
i) opening said door, wherein said door is arranged such that when in its opened position said interior region of said molding chamber communicates with said parts discharge region through said passage.

12. A vacuum injection press, comprising:
a) a structure defining a sealable molding chamber and a passage communicating an interior region of said chamber with a parts discharge region spaced from said interior region, said passage being configured to permit parts molded in said molding chamber to pass through said passage and into said parts discharge region;
b) a door moveable between open and closed positions for controlling communication between said interior chamber region and said parts discharge region, through said passage;
c) said door arranged such that when in its opened position said interior region of said molding chamber communicates with said parts discharge region through said passage and when in its closed position, said door substantially inhibits fluid communication between said molding chamber and said parts discharge region;
d) a parts receiving receptacle moveable into and out of said parts discharge region and sealingly engageable with said structure such that when said structure is engaged by said receptacle, said receptacle defines a parts receiving zone that is isolated from a remainder of the parts discharge region and said passage communicating said molding chamber with said zone when said door moves to said opened position so that parts discharged from said molding chamber enter said zone;
e) a source of vacuum including a first control for communicating said vacuum source with said molding chamber and a second control for controlling the communication of said vacuum source with said parts receiving zone defined by said parts receiving receptacle under predetermined operating conditions; and
f) said first control maintaining a vacuum condition in said molding chamber when said molded parts are passing from said molding chamber to said parts discharge region, such that said molding chamber does not have to be reevacuated between molding cycles.
